(19) United States
(12) Patent Application Publication
(10) Pub. No.: US 2017/0009812 A1
(43) Pub. Date: Jan. 12, 2017

(54) BEARING ASSEMBLY COVER

(71) Applicant: GM GLOBAL TECHNOLOGY OPERATIONS LLC, Detroit, MI (US)

(72) Inventors: Avissai Alcantara Burguete, Mexico City (MX); Arthur C. Valverde, Clinton Township, MI (US); Abundio Silva Luna, State of Mexico (MX)

(21) Appl. No.: 14/795,391

(22) Filed: Jul. 9, 2015

(51) Int. Cl. F16C 33/72

(52) U.S. Cl. CPC F16C 33/723

(57) ABSTRACT

A bearing assembly cover for placement over a shaft mounted bearing assembly comprises a flanged base configured for attachment to a bearing case of the bearing assembly and a hollow frusto-conical portion extending outwardly from the flanged base, and narrowing from the base, to an open end wherein the open end extends about the shaft.

### FIELD OF THE INVENTION

The subject invention is related to drive systems for motor vehicles and, more particularly, to a bearing cover for a drive system bearing assembly that thermally protects the bearing while shielding the bearing from contamination and splash.

### BACKGROUND

Vehicle drive systems typically utilize rotatable shafts supported by lubricated bearing assemblies that require a relatively clean, sealed environment to remain robust. The durability of a bearing assembly is compromised by high temperatures which may degrade the lubrication. Bearing seals that are used to keep lubrication in and dirt, contamination and moisture out may be damaged by high temperatures. Likewise, moisture and corrosives such as road salt can also affect the durability of the bearing assembly. One solution to the above durability challenges is to significantly increase the protection to the bearing assembly by adding static seals, slingers and shields. Such solutions will significantly increase the cost of a bearing assembly. It is desirable to increase the durability of a standard bearing assembly using a less costly system while having improved effectiveness.

### SUMMARY

In an exemplary embodiment a bearing assembly cover for placement over a shaft mounted bearing assembly comprises a flanged base configured for attachment to a bearing case of the bearing assembly and a hollow frusto-conical portion extending outwardly from the flanged base, and narrowing from the base, to an open end wherein the open end extends about the shaft.

In another embodiment, a vehicle having a drive system comprises a rotatable shaft support member fixed to a rigid member of the vehicle, a bearing case mounted to the rotatable shaft support and configured to receive a bearing assembly therein, a rotatable shaft, rotatably supported by the bearing assembly; and a bearing assembly cover for placement over the bearing assembly comprising a flanged base configured for attachment to the bearing case and a hollow, frusto-conical portion extending outwardly from the flanged base, and narrowing from the base, to an open end wherein the open end extends about the shaft.

The above features and advantages, and other features and advantages of the invention, are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a partial view of a portion of a vehicle including an engine, suspension and drive system embodying features of the invention;

FIG. 2 is a disassembled view of a portion of the drive system illustrated in FIG. 1; and

FIG. 3 is a perspective view of a bearing assembly cover embodying features of the invention.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts or features. As used herein, the term motor vehicle is not limited to just an automobile, truck, van or sport utility vehicle, but includes any self-propelled or towed conveyance suitable for transporting a burden. The embodiments shown are applicable to vehicle components, but the system disclosed herein may be used in any suitable applications in which rotating components are subject to support in corresponding bearing assemblies (ex. transportation, energy, machinery and aerospace applications).

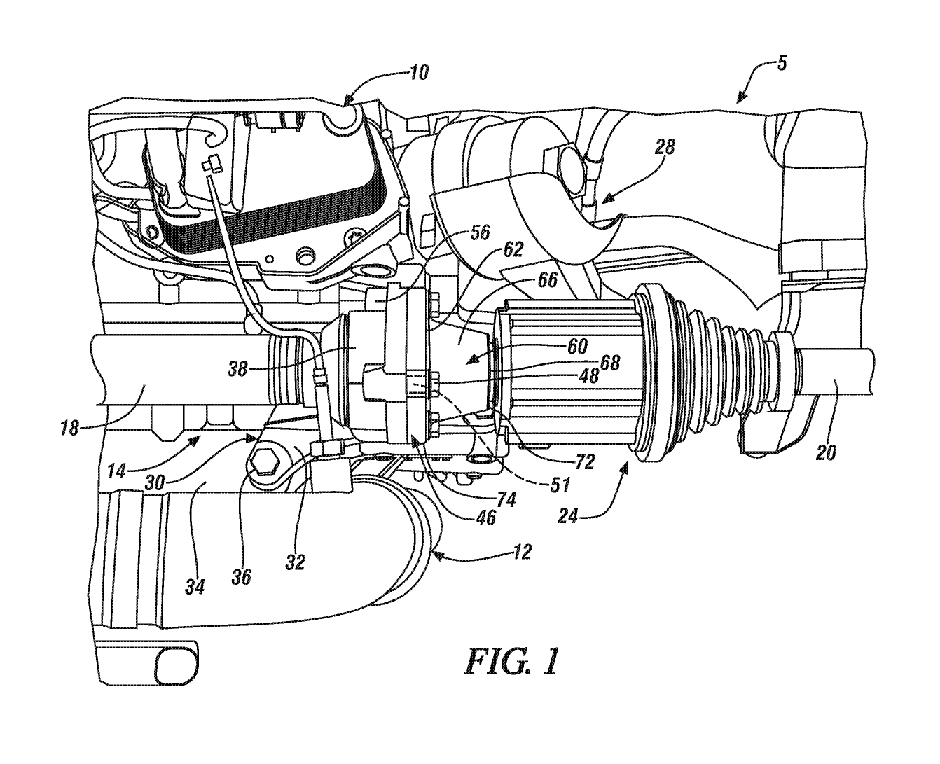

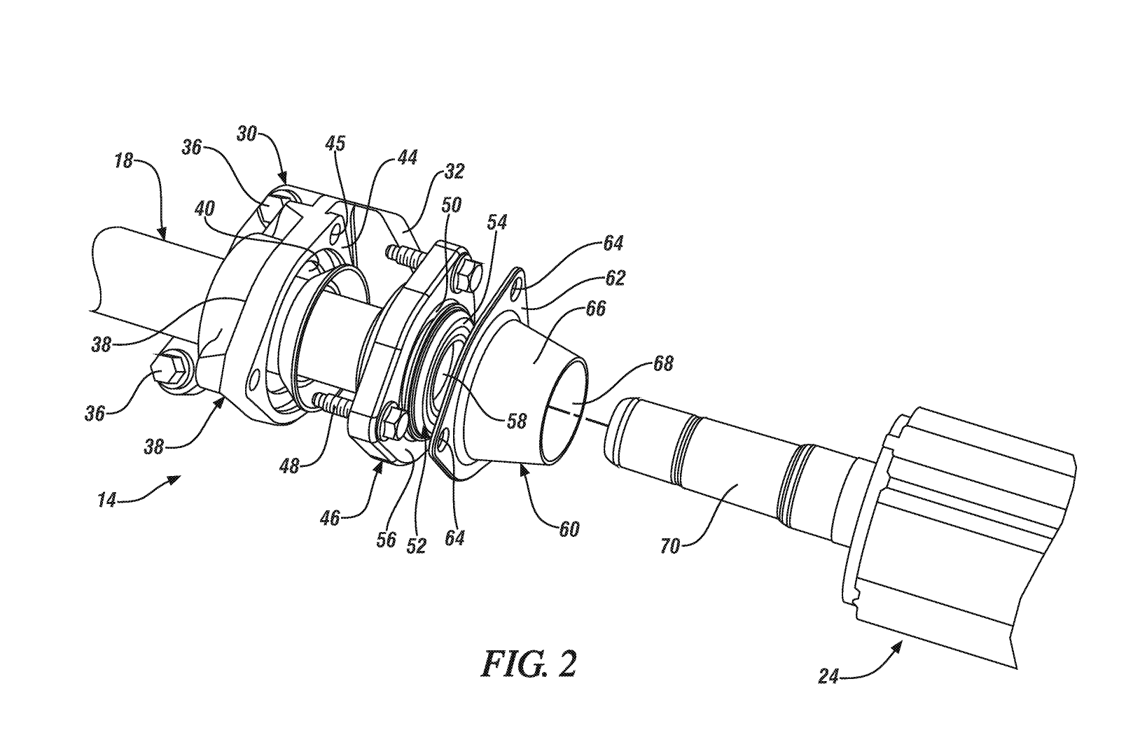

Referring now to FIGS. 1 and 2, a motor vehicle 5 comprises an internal combustion (“IC”) engine 10 that expels hot exhaust gas as a product of combustion. The hot exhaust gas is removed from the internal combustion engine 10 via an exhaust system 12 that generally extends under the motor vehicle 5 in an axial direction from the front of the vehicle rearward (in a front engine vehicle). A drive system 14 receives rotating power from the IC engine 10, through a transmission (not shown) and transmits that power to road wheels (not shown) in order to move the vehicle 5 under the power of the engine 10.

The drive system 14 generally comprises a number of rotatable shafts including, in an embodiment, a prop-shaft 18 and a drive shaft or half-shaft 20 outboard of the prop-shaft. Such an assembly of shafts may apply to both sides of the motor vehicle 5. Disposed between the rotatable shafts 18, 20 is a constant velocity “CV” joint 24. Specifically inner “CV” joint 24 connects prop-shaft 18 with half shaft 20. The CV joints 24 allows for motion in virtually all directions so that the drive system 14 can absorb the various inputs from the road that must be absorbed by the suspension system 28 as well as outputs provided by vehicle systems such as the steering system (not shown).

A prop-shaft support member 30 includes a base 32 that, in an embodiment, is fixed to a rigid member of the IC engine 10 such as the cast oil pan 34. Fasteners such as bolts 36 are used to attach the base 32 of the support member 30 to the oil pan 34 through openings therein. A prop-shaft support portion 38 extends outwardly from the base 32 and includes a through-bore 40 extending therethrough. A mounting face 44, machined on a first side of the prop-shaft support portion 38, includes threaded openings 45 and is configured to securely receive a bearing case 46 using fasteners, such as threaded bolts 48, which pass through corresponding openings (not shown) in the bearing case. The bearing case 46 has a through-bore 50 that corresponds to the through-bore 40 of the prop-shaft support portion 38, in the prop-shaft support member 30, to receive a prop-shaft bearing assembly 52 therein. The prop-shaft bearing assembly 52 is, in an embodiment, press-fit into the through-bore 50 of the bearing case 46 and is configured to rotatably support an end of the prop-shaft 18, a shaft 70 of the CV joint 24 or a combination thereof when the bearing case 46 is securely fastened to the prop-shaft support member 30.

Referring now to FIGS. 1-3, in an embodiment, a bearing assembly cover 60 is employed to provide the outer face 54 of the prop-shaft bearing assembly 52 with protection from thermal cycling damage that may be caused by its close proximity to the exhaust system 12, as well as from moisture and corrosives such as road salt and damage from impact due to the bearing's underbody placement. The bearing assembly cover 60 includes a flanged base 62 that, in an embodiment, has a series of openings 64 that receive fasteners 48 therethrough. A hollow frusto-conical portion 66 extends outwardly from the flanged base 62, narrowing from the base 62, to an open end 68. The bearing assembly cover 60 may be constructed of plastic, metal, high temperature composite or any other material that provides the requisite performance in the described environment. The flanged base 62 is configured to complement the outer face 56 of the bearing case 46 such that the openings 64 align with the fastener openings 51. The threaded bolts 48 may thereby retain the bearing assembly cover 60 securely fastened over the outer face 56 of the bearing assembly 52 by attaching it to the bearing case 46. In another embodiment, the flanged base 62 may dispense with the series of openings 64 and instead utilize an alternative fastening system to retain the bearing assembly cover over the outer face 54 of the bearing case 46. It is contemplated that the flanged base 62 may be welded, glued or otherwise fixed to the bearing case 46 or may be clamped using clamping members (not shown) as fasteners.

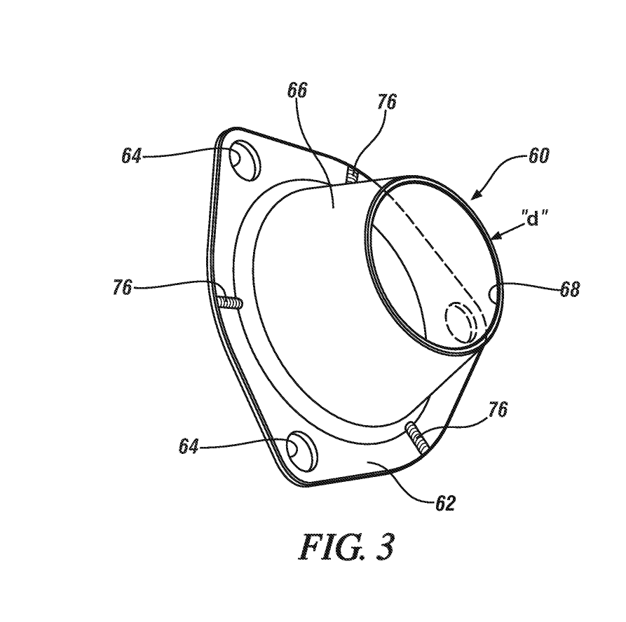

The diameter “d” of the open end 68 of the hollow frusto-conical portion 66 is sized to allow the shaft 70 of the inner CV joint 24 to pass therethrough and enter, in an embodiment, the opening 58 defined by the bearing inner race for support therein. The diameter “d” may be sized in a manner that provides little or no space or clearance between the open end 68 of the frusto-conical portion 66 and the surface of the shaft 70 in order to prevent the ingress of moisture and contaminants into the interior of the bearing assembly cover 60. In an alternate embodiment, the diameter “d” may be sized in a manner that defines a minimal space or clearance 72, FIG. 1, between the open end 68 of the frusto-conical portion 66 and the surface of the shaft 70 in order to moderate temperature excursions in the interior of the bearing assembly cover. Regardless of the size of the clearance 72 between the open end 68 of the bearing assembly cover 60 and the surface of the shaft 70 the drainage of any moisture or contaminants may, in an embodiment, be achieved through a drainage space 74 that is defined between the flanged base 62 and the bearing case outer face 56 of the bearing case 46. In an embodiment, hollow ribbed portions 76, FIG. 3, may extend radially outwardly in the flanged base 62 to provide drainage space as the bearing assembly 52 and attached bearing assembly cover 60 rotate.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation of material to the teachings of the invention without departing from the essential scope thereof. Therefore, it is intended that the invention not be limited to the particular embodiments disclosed, but that the invention will include all embodiments falling within the scope of the application.

What is claimed is:

1. A bearing assembly cover for placement over a shaft mounted bearing assembly comprising:
a flanged base configured for attachment to a bearing case of the bearing assembly; and
a hollow frusto-conical portion extending outwardly from the flanged base, and narrowing from the base, to an open end wherein the open end extends about the shaft.

2. The bearing assembly cover of claim 1, further comprising a series of openings in the flanged base that receive fasteners for attachment of the bearing assembly cover to the bearing case.

3. The bearing assembly cover of claim 1, wherein the flanged base is welded or glued to the bearing case.

4. The bearing assembly cover of claim 1, the open end having a diameter “d” sized to allow the shaft to pass therethrough.

5. The bearing assembly cover of claim 4, wherein the diameter “d” is sized to provide little or no space or clearance between the open end of the frusto-conical portion and the shaft to prevent the ingress of moisture and contaminants into the interior of the bearing assembly cover.

6. The bearing assembly cover of claim 4, wherein the diameter “d” is sized to provide a minimal space or clearance between the open end of the frusto-conical portion and the shaft to prevent a temperature build-up in the interior of the bearing assembly cover.

7. The bearing assembly cover of claim 1, further comprising a drainage space that is defined between the flanged base and the bearing case.

8. The bearing assembly cover of claim 7, wherein the drainage space comprises radially outwardly extending hollow ribbed portions.

9. A vehicle having a drive system comprising:
a rotatable shaft support member fixed to a rigid member of the vehicle;
a bearing case mounted to the rotatable shaft support and configured to receive a bearing assembly therein;
a rotatable shaft, rotatably supported by the bearing assembly; and
a bearing assembly cover for placement over the bearing assembly comprising a flanged base configured for attachment to the bearing case and a hollow, frusto-conical portion extending outwardly from the flanged base, and narrowing from the base, to an open end wherein the open end extends about the shaft.

10. The vehicle of claim 9, further comprising a series of openings in the flanged base that receive fasteners for attachment of the bearing assembly cover to the bearing case.

11. The vehicle of claim 9, wherein the flanged base is welded or glued to the bearing case.

12. The vehicle of claim 9, the open end having a diameter “d” sized to allow the shaft to pass therethrough.

13. The vehicle of claim 12, wherein the diameter “d” is sized to provide little or no space or clearance between the open end of the frusto-conical portion and the shaft to prevent the ingress of moisture and contaminants into the interior of the bearing assembly cover.

14. The vehicle of claim 12, wherein the diameter “d” is sized to provide a minimal space or clearance between the open end of the frusto-conical portion and the shaft to prevent a temperature build-up in the interior of the bearing assembly cover.

15. The vehicle of claim 9, further comprising a drainage space that is defined between the flanged base and the bearing case.

16. The vehicle of claim 15, wherein the drainage space comprises radially outwardly extending hollow ribbed portions.

17. The vehicle of claim 9, wherein the rotatable shaft is a prop shaft.

18. The vehicle of claim 9, wherein the rotatable shaft is a constant velocity joint shaft.
